(19) United States
(12) Patent Application Publication
(10) Pub. No.: US 2015/0085425 A1
(43) Pub. Date: Mar. 26, 2015

(54) SUPERCAPACITOR ELECTRODES AND ASSOCIATED METHODS OF MANUFACTURING

(71) Applicant: John Q. XIAO, Newark, DE (US)

(72) Inventors: John Q. Xiao, Newark, DE (US); Qi Lu, Newark, DE (US); Karil M. Unruh, Newark, DE (US)

(73) Assignee: John Q. XIAO, Newark, DE (US)

(21) Appl. No.: 14/396,936

(22) PCT Filed: Apr. 24, 2013
(86) PCT No.: PCT/US13/37916

§ 371 Date: Oct. 24, 2014

Related U.S. Application Data
(60) Provisional application No. 61/638,089, filed on Apr. 25, 2012.

(51) Int. Cl. H01G 11/42; B22F 3/24; H01G 11/46; B22F 3/02; H01G 11/04; H01G 11/26

(52) U.S. Cl. CPC H01G 11/42; H01G 11/04; H01G 11/26; H01G 11/46; B22F 3/02; B22F 3/24; B22F 2003/248; B22F 2003/242
USPC 361/502; 419/66

(57) ABSTRACT

Electrodes and their associated methods of manufacturing are disclosed. An electrode comprises a metal body, a conductive coating, and a metal oxide layer. The metal body is formed from a plurality of compacted metal nanoparticles. The conductive coating is formed on a first side of the metal body. The conductive coating comprises a conductive material. The metal oxide layer is formed on a second side of the metal body. The metal oxide layer includes a plurality of metal oxide nanoparticles. The electrode may be used in a supercapacitor. A method for fabricating an electrode comprises synthesizing a plurality of metal nanoparticles, compacting the plurality of metal nanoparticles into a metal body, depositing a conductive coating on a first side of the metal body, and forming a metal oxide layer on a second side of the metal body.

### CROSS-REFERENCE TO RELATED APPLICATIONS

This application claims priority to U.S. Patent Application No. 61/638,089, filed Apr. 25, 2012, entitled “SUPERCAPACITOR ELECTRODES AND ASSOCIATED METHODS OF MANUFACTURING,” the content of which is incorporated herein by reference.

### STATEMENT REGARDING FEDERALLY SPONSORED RESEARCH

This invention was made with government support under Grant No. N000140810423 awarded by the Office of Naval Research. The government has certain rights in this invention.

### FIELD OF THE INVENTION

The present invention relates generally to electrode manufacturing, and more particularly, to methods of manufacturing metal nanocomposite electrodes for supercapacitors.

### BACKGROUND OF THE INVENTION

Supercapacitors are highly desirable energy storage devices because of their ability to simultaneously deliver high power and reasonably high energy densities. Unfortunately, several major problems have prevented supercapacitors from becoming primary power supplies that are commercially viable. In particular, the energy density historically has not been high enough, and most fabrication processes have not been appropriate for manufacture at large scales.

There are two different mechanisms of supercapacitance: electrochemical double layer capacitance and pseudocapacitance. Electrochemical double layer capacitance involves storing the charge electrostatically using reversible adsorption of ions of the electrolyte onto active materials that are electrochemically stable and have high accessible specific surface area (as shown in FIG. 1A). Some transition metal oxides, however, not only store charge between the electrode and electrolyte interfaces but further employ a fast and reversible redox reaction between electrodes and the electroactive species in electrolytes to store additional charge as pseudocapacitance (as shown in FIG. 1B).

### SUMMARY OF THE INVENTION

Aspects of the present invention are directed to electrodes and their associated methods of manufacturing.

In accordance with one aspect of the present invention, an electrode is disclosed comprising a metal body, a conductive coating, and a metal oxide layer. The metal body is formed from a plurality of compacted metal nanoparticles. The conductive coating is formed on a first side of the metal body. The conductive coating comprises a conductive material. The metal oxide layer is formed on a second side of the metal body. The metal oxide layer includes a plurality of metal oxide nanoparticles.

In accordance with another aspect of the present invention, a supercapacitor is disclosed comprising an electrode that comprises a metal body, a conductive coating, and a metal oxide layer. The metal body includes a plurality of compacted metal nanoparticles. The conductive coating is formed on a first side of the metal body. The conductive coating comprises a conductive material. The metal oxide layer is formed on a second side of the metal body. The metal oxide layer includes a plurality of metal oxide nanoparticles.

In accordance with yet another aspect of the present invention, a method for fabricating an electrode is disclosed. The method comprises synthesizing a plurality of metal nanoparticles, compacting the plurality of metal nanoparticles into a metal body, depositing a conductive coating on a first side of the metal body, and forming a metal oxide layer on a second side of the metal body.

### BRIEF DESCRIPTION OF THE DRAWINGS

The invention is best understood from the following detailed description when read in connection with the accompanying drawings, with like elements having the same reference numerals. When a plurality of similar elements are present, a single reference numeral may be assigned to the plurality of similar elements with a small letter designation referring to specific elements. When referring to the elements collectively or to a non-specific one or more of the elements, the small letter designation may be dropped. According to common practice, the various features of the drawings are not drawn to scale unless otherwise indicated. To the contrary, the dimensions of the various features may be expanded or reduced for clarity. Included in the drawings are the following figures:

FIGS. 1A and 1B are diagrams illustrating two mechanisms of supercapacitance;

FIG. 2 is a diagram illustrating an exemplary electrode in accordance with aspects of the present invention;

FIG. 3 is an image illustrating an exemplary metal oxide layer of the electrode of FIG. 2;

FIG. 4 is a flow chart illustrating an exemplary method for fabricating an electrode in accordance with aspects of the present invention;

FIGS. 5A and 5B are graphs illustrating charge characteristics of exemplary electrodes in accordance with aspects of the present invention; and

FIGS. 6A and 6B are graphs illustrating additional charge characteristics of exemplary electrodes in accordance with aspects of the present invention.

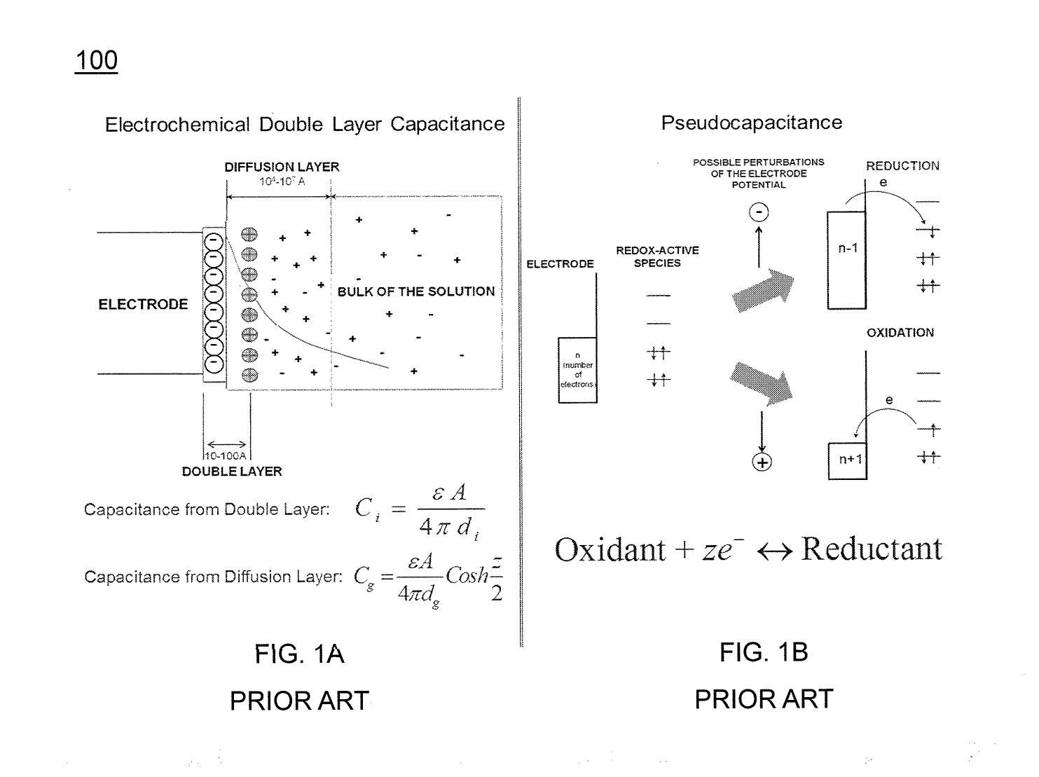

### DETAILED DESCRIPTION OF THE INVENTION

Aspects of the present invention are directed to fabricating advanced electrodes for an electrochemical-type capacitor with high-energy and high-power densities.

Aspects of the present invention are particularly suitable to provide a simple, cost-effective, and scalable technique for fabricating support-free and additive-free metal oxide/metal nanocomposite electrodes for use in electrochemical supercapacitors or in batteries. The nanostructured conductive metal core network desirably minimizes the polarization loss across the electrode material, and therefore is particularly suitable for high power applications. The controlled crystallinity of metal oxides maximizes the utilization of functional material and achieves high energy densities. Accordingly, by applying a slow charge/fast discharge process, high energy densities of approximately 60 Wh/kg and high power densities of approximately 10 kW/kg can be simultaneously achieved.

Aspects of the present invention relate generally to the manufacture and use of nanostructured electrodes for superconductors. The large surface area created by nanoscale structures significantly enhances the efficiency in utilizing the electrode material, and therefore improves the electrode's performance. The disclosed exemplary methods enable one to build advanced supercapacitor electrodes using a simple and io scalable fabrication technique and to optimize the electrode performance using a controlled functional material and a well-defined electrode network with minimum resistivity.

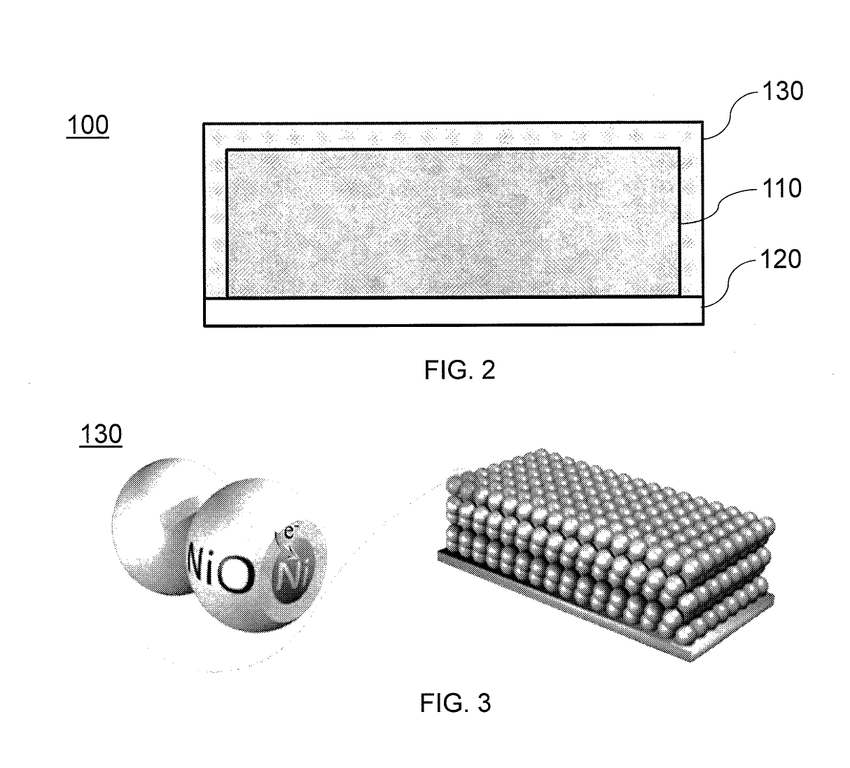

Referring now to the drawings, FIG. 2 illustrates an exemplary electrode 100 in accordance with aspects of the present invention. The electrode may be used, for example, in a supercapacitor. As a general overview, electrode 100 includes a metal body 110, a conductive coating 120, and a metal oxide layer 130. Additional details of electrode 100 are described below.

Metal body 110 forms the body of electrode 100. Metal body 110 is formed from a plurality of compacted metal nanoparticles. Metal body 110 includes no binders or supports for affixing the plurality of compacted metal nanoparticles to each other. The metal nanoparticles are instead adhered to one another via the compaction process, as will be described in greater detail below. In an exemplary embodiment, metal body 110 consists only of the compacted metal nanoparticles. The compacted metal nanoparticles may include at least one transition or other metal, preferably a metal selected from the group consisting of nickel, cobalt, manganese, iron, bismuth, ruthenium, rhodium, iridium, vanadium, titanium, molybdenum, tungsten and any alloy thereof.

Conductive coating 120 is formed on one side of metal body 110. Conductive coating 120 comprises a conductive material. Suitable conductive materials include, for example, platinum, gold, silver, or any alloy thereof. Conductive coating 120 may serve for connecting electrode 100 to the current-carrying portions of the supercapacitor.

Metal oxide layer 130 is formed on the surface of metal body 110. Metal oxide layer includes a plurality of metal oxide nanoparticles (or metal/metal oxide nanocomposites). In an exemplary embodiment, the metal/metal oxide nanocomposites include an oxide of the same metal used in metal body 110. The metal/metal oxide nanocomposites may comprise a coating of metal oxide around a metal core network, as shown in FIG. 3. Preferably, the metal oxide nanoparticles have a grain size of between approximately 1-100 nm.

As explained above, electrode 100 may be included in a supercapacitor. An exemplary supercapacitor includes one or more electrodes 100. The materials of electrodes 100 may be selected based on the respective electrode's use within the supercapacitor. As will be understood by one of ordinary skill in the art, a supercapacitor includes a positive electrode and a negative electrode. In an exemplary embodiment, where electrode 100 is used as a positive electrode in the supercapacitor, metal body 110 comprises nickel nanoparticles, and metal oxide layer 130 comprises nickel oxide nanoparticles. In another exemplary embodiment, where electrode 100 is used as a negative electrode in the supercapacitor, metal body 110 comprises iron or manganese nanoparticles, and metal oxide layer 130 comprises iron oxide or manganese oxide nanoparticles, respectively.

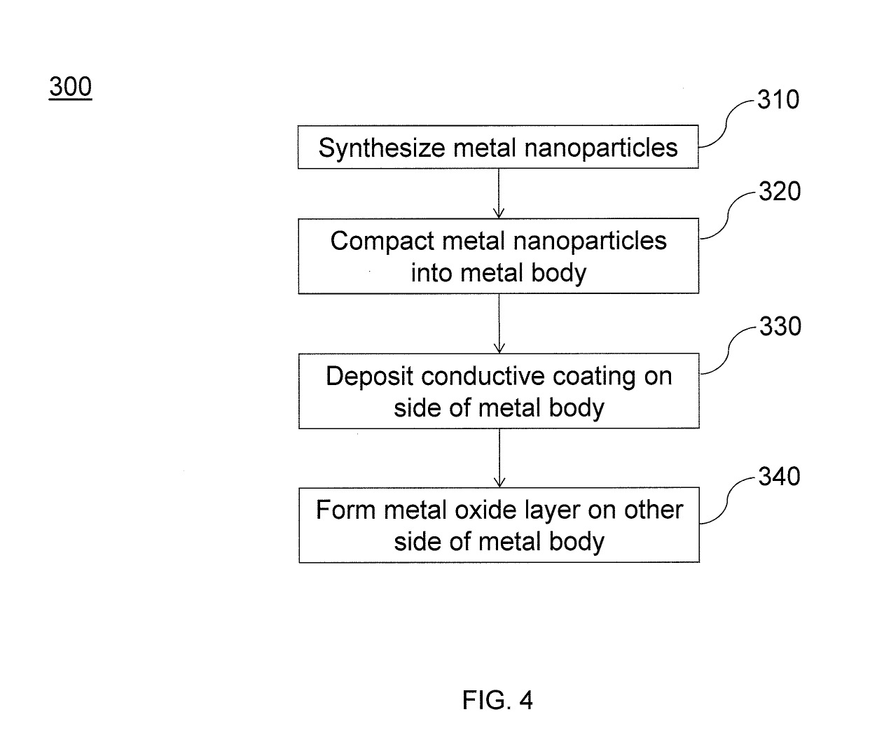

FIG. 4 illustrates an exemplary method 300 for fabricating an electrode in accordance with aspects of the present invention. The electrode may be fabricated, for example, as part of a supercapacitor. As a general overview, the method includes synthesizing metal nanoparticles, compacting the nanoparticles, depositing a conductive coating, and forming a metal oxide layer. Additional details of electrode 100 are described below.

In step 310, metal nanoparticles are synthesized. In an exemplary embodiment, the metal nanoparticles are synthesized using a polyol method. Other suitable methods for synthesizing metal nanoparticles will be known to one of ordinary skill in the art from the description herein.

As set forth above, the metal nanoparticles may be synthesized by a modified polyol process, or other methods such as chemical reduction and decomposition, sol-gel, sonochemical, microemulsion, hydrothermal, thermal evaporation and condensation, and CVD. In an exemplary process, solid NiCl₂.6 H₂O (Alfa Aesar, 1.0 g) is dissolved in ethylene glycol (Alfa Aesar, 250 mL) at room temperature by mechanical stirring. The solution is then heated to reflux at 195(±2)° C. Once a stable temperature is reached, solid NaBH₄ (Strem Chemicals, 2.0 g) is added to the solution as a reducing agent. The mixture is subsequently maintained at reflux for 30 min and then cooled to room temperature. The resulting particles may be magnetically isolated, repeatedly washed in a sonicated bath with acetone and ethyl alcohol, and then dried in vacuum at 100° C. overnight.

The structure of the as-prepared metal nanoparticles may be characterized by X-ray diffraction and/or by electron diffraction. In an exemplary embodiment, the particle size is estimated to be approximately 4.4 nm in diameter, though several particles may form larger aggregates with a diameter smaller than 20 nm.

In step 320, the metal nanoparticles are compacted into a metal body. The metal nanoparticles may be mechanically compacted into metal body 110. Suitable devices for mechanically compacting metal nanoparticles will be known to one of ordinary skill in the art from the description herein.

In an exemplary embodiment, an exemplary electrode 100 for a supercapacitor are prepared by mechanically compacting a specified mass (e.g., 5 mg) of metal nanoparticle powder in a hydraulic press to produce thin pellet disks of 4 mm in diameter. These pellets are stable, easy to handle, and require neither additives nor a supporting substrate.

Scanning electron microscopic images obtained at both the surface and cross-section of these pellets reveal a highly porous structure formed by a network of metal nanoparticles. Measurements of these pellets suggest that most of the surface area of the nanoparticles is not affected by the preparation technique.

In step 330, a conductive coating is deposited on one side of the metal body. In an exemplary embodiment, conductive coating 120 is deposited on a side of metal body 110. Conductive coating 120 may be deposited, for example, by sputter coating. Alternatively, conducting coating 120 may be deposited by conventional vapor deposition techniques. Where metal body 110 is formed from a conductive metal, step 330 may be omitted.

In step 340, a metal oxide layer is formed on another side of the metal body. In an exemplary embodiment, metal oxide layer 130 is formed on a side of metal body 110 opposite conductive coating 120. Metal oxide layer 130 may be formed, for example, by thermally treating metal body 110 to form a plurality of metal oxide layers 130. The thermal treatment comprises heating metal body 110 at a temperature between approximately 100° C. and approximately 800° C. Desirably, the thermal treatment process is performed a temperature between approximately 100° C. and approximately 800° C., and most desirably between 200° C. and 500° C. The thermal treatment is performed in the presence of air or oxygen. Additional details regarding the thermal treatment are provided below.

The metal oxide layer may be created by a relatively low temperature thermal treatment in atmospheric air. Its crystallinity can be tuned by varying the annealing temperatures. For example, at 250° C., a nickel oxide phase may be formed having very small crystallites. The optimized temperature for a specific metal or alloy may be determined by thermal analysis, X-ray diffraction characterizations, and electrochemical characterizations. The ratio of metal nanoparticles and metal oxide nanoparticles can be determined by comparing the magnetization loss between the electrodes before and after the thermal treatment process.

Method 300 is not limited to the above steps, but may include alternative or additional steps, as set forth below.

For example, method 300 may further include the step of minimizing the crystallinity of the metal oxide nanoparticles. In an exemplary embodiment, the crystallinity of the metal oxide nanoparticles is minimized such that the metal oxide nanoparticles have a grain size of between approximately 1-100 nm.

An exemplary electrode fabricated by the above-described method may achieve the following advantages:

1. Tuned pore sizes by the initial particle sizes.

2. High conductivity provided by the metal core network.

3. Controlled crystallinity by optimization of thermal treatments.

An exemplary electrode fabricated by the above-described method is highly conductive, having a resistivity typically less than 1 Ωcm. Its IV curve behaves like a metal, indicating the conductive metal core network is well retained after the oxidation. Relatively high temperature counterparts (annealed at >250° C.), however, are more than one order magnitude higher in resistivity. The IV curve shows a tunneling effect indicating the intensive oxidation has isolated the metal core.

More intense oxidation at higher temperatures have thicker oxide layers, which tend to isolate the conductive cores and gives rise to a much higher ohmic resistivity of the electrode. The ohmic resistivity of the electrode reduces the utilization of the electrode material because of polarization loss. High utilization of the electrode has been observed for a sample oxidized at low temperature, indicating that the electrode performance is enhanced by a small ohmic resistivity originating from the conductive metal core networks. Accordingly, it may be particularly desirable that the thermal treatment process be performed at a temperature of 250° C. or lower. Higher temperatures also tend to result in oxides layers having higher crystallinity, which decreases the utilization of active materials (oxides).

The exemplary embodiments described herein differ from conventional fabrication methods and products produced thereby for the following reasons.

Conventional fabrication methods are unable to simultaneously tailor the electrode conductivity and crystallinity during fabrication of the electrode. Further, conventional methods do not produce electrodes having an effective current collector network. Therefore, they are not able to fabricate thick electrodes with desirable conductivity.

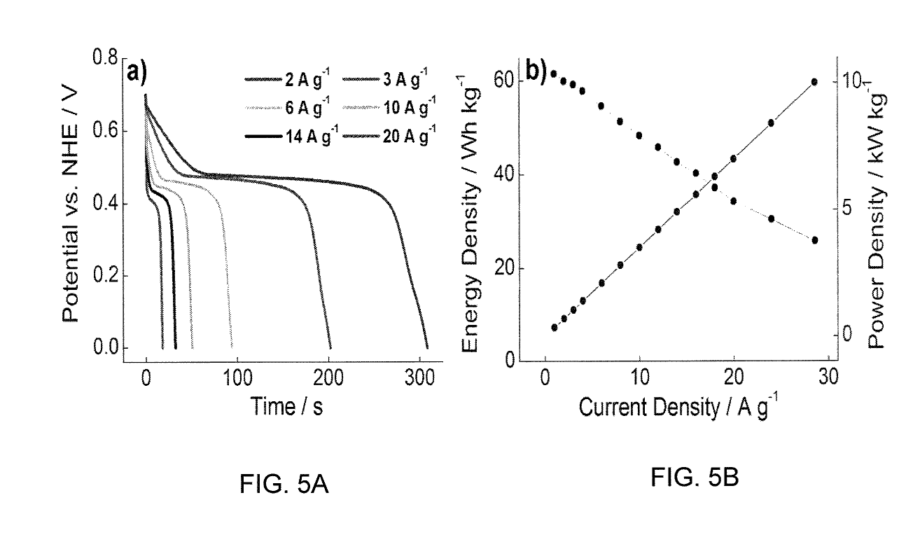

One important advantage of supercapacitors is their much higher power density relative to that of ordinary batteries. Therefore, the high-power performance of the electrodes of the present invention was characterized by a series of cyclic chronopotentiometric measurements with charge/discharge current densities up to 28.6 A/g (which correspond to power densities up to 10 kW/kg). FIGS. 5A and 5B illustrate charge characteristics of exemplary electrodes of the present invention with constant charge/discharge current densities.

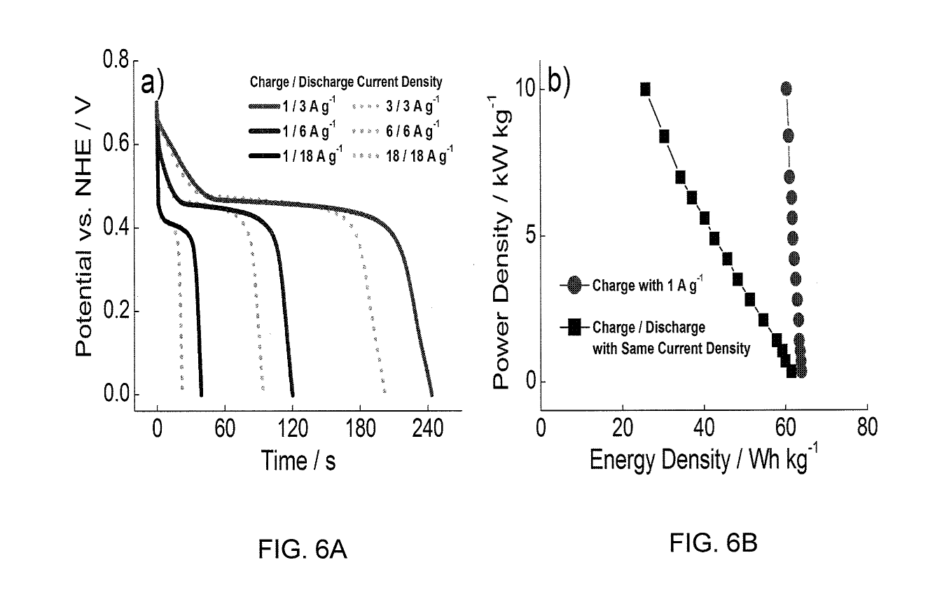

The reversible redox reaction associated with pseudocapacitance is a highly diffusion-controlled process. Therefore, it can be expected that the specific capacitance (SC), and thus the obtained energy density, will decrease at a fast charge/discharge rate. As shown in FIG. 6B, at a slow charge/discharge rate (1 A/g) a high-energy density of 62 Wh/kg (equivalent to 905 F/g for the SC) was observed for exemplary electrodes of the present invention.

However, the power density achieved at this rate (ca. 0.4 kW/kg) was small relative to that of conventional electrochemical double-layer capacitors (EDLCs) which show a fast mechanism for the storage of surface charges. As the charge/discharge rate was increased to 28.6 A/g, a high-power density of 10 kW/kg was achieved, as shown in FIG. 6B. Although the corresponding energy density dropped to 26 Wh/kg (equivalent to 380 F/g for the SC), it still is one of best performances reported so far.

In most applications that require an energy storage system the process of energy collection is usually slow (e.g., wind or solar power plant), but the stored energy must be released rapidly to meet the power demands of these applications. Therefore, the exemplary NiO/Ni nanocomposite electrodes were first charged at a small current density (1 A/g) and then discharged at a series of higher discharge rates. The power densities of discharge, average specific capacitances of discharge, and calculated energy densities of discharge were obtained from the discharge portion of the cyclic chronopotentiometric curves. FIGS. 6A and 6B illustrate charge characteristics of exemplary electrodes of the present invention with differing charge/discharge current densities. As shown in FIGS. 6A and 6B, the energy density of discharge is only slightly affected by the discharge rates. Outstanding performances of high energy (ca. 60 Wh/kg) and high-power densities (10 kw/kg) were simultaneously achieved.

In addition to the above energy and power densities, conventional methods use additional binders, additives, and substrates to fabricate electrodes. Therefore, the performance in unit weight or volume for the resulting devices is undesirably reduced. Further, conventional methods tend to be high in cost and difficult for commercial production at large scale.

To the contrary, the electrodes of the present invention achieve far superior performance to conventional electrodes. The electrodes are robust, monolithic, additive-free and binder-free. The exemplary fabrication method described herein is comparatively simple and feasible for commercial production.

Although the invention is illustrated and described herein with reference to specific embodiments, the invention is not intended to be limited to the details shown. Rather, various modifications may be made in the details within the scope and range of equivalents of the claims and without departing from the invention.

1. A supercapacitor electrode comprising:
a metal body comprising a compacted porous network of metal nanoparticles of a first metal or combination of metals having no binders or supports affixing the metal nanoparticles to each other;
a conductive coating formed on a first side of the metal body, the conductive coating comprising a conductive material; and
a plurality of metal oxide layers formed on a second side of the metal body, the plurality of metal oxide layers comprising a porous network of metal oxide nanoparticles comprising an oxide of the first metal or combination of metals and having no binders or supports affixing the metal oxide nanoparticles to each other.

2. The supercapacitor electrode of claim 1, wherein the porous network of metal nanoparticles include at least one metal selected from the group consisting of nickel, cobalt, manganese, iron, bismuth, ruthenium, rhodium, iridium, vanadium, and any alloy thereof.

3.-4. (canceled)

5. The supercapacitor electrode of claim 1, wherein the plurality of metal oxide nanoparticles have a grain size of between approximately 1-100 nm.

6. The supercapacitor electrode of claim 1, wherein the supercapacitor electrode has a resistivity less than 1 Ωcm.

7. The supercapacitor electrode of claim 1, wherein the plurality of metal oxide layers comprise layers formed by oxidization of surface layers of the metal body.

8. A supercapacitor comprising a supercapacitor electrode, the supercapacitor electrode comprising:
a metal body comprising a compacted porous network of metal nanoparticles having no binders or supports affixing the metal nanoparticles to each other;
a conductive coating formed on a first side of the metal body, the conductive coating comprising a conductive material; and
a plurality of metal oxide layers formed on a second side of the metal body, the metal oxide layer comprising a porous network of metal oxide nanoparticles having no binders or supports affixing the metal oxide nanoparticles to each other.

9. The supercapacitor of claim 8, wherein the supercapacitor electrode is a positive electrode, and
wherein the porous network of compacted metal nanoparticles comprise nickel or an alloy thereof, and
wherein the porous network of metal oxide nanoparticles comprise nickel oxide or an oxide of the nickel alloy.

10. The supercapacitor of claim 8, wherein the supercapacitor electrode is a negative electrode, and
wherein the porous network of compacted metal nanoparticles comprises iron or an alloy thereof or manganese or an alloy thereof, and
wherein the porous network of metal oxide nanoparticles comprises iron oxide, manganese oxide, an oxide of the iron alloy, or an oxide of the manganese alloy.

11. A method for fabricating a supercapacitor electrode comprising the steps of:
synthesizing a plurality of metal nanoparticles;
compacting the plurality of metal nanoparticles into a metal body comprising a porous network of the metal nanoparticles having no binders or supports affixing the metal nanoparticles to each other;
depositing a conductive coating on a first side of the metal body; and
forming a plurality of metal oxide layers on a second side of the metal body.

12. The method of claim 11, wherein the synthesizing step comprises synthesizing the plurality of metal nanoparticles using a polyol method.

13. The method of claim 11, wherein the compacting step comprises mechanically compacting the metal nanoparticles.

14. The method of claim 11, wherein the forming step comprises thermally treating the metal body to form the plurality of metal oxide layers.

15. The method of claim 14, wherein the thermal treatment is performed by heating the metal body at a temperature between 100° C. and 800° C.

16. The method of claim 15, wherein the thermal treatment is performed by heating the metal body at a temperature between 200° C. and 500° C.

17. The method of claim 16, wherein the plurality of metal nanoparticles comprise nickel or an alloy thereof.

18. The method of claim 15, wherein the thermal treatment temperature is selected such that the resulting electrode has a resistivity less than 1 Ωm.

19. The electrode of claim 11, wherein the supercapacitor electrode achieves a high-energy density of at least 60 wh/kg at a charge/discharge rate of 1 A/g, and an energy density of at least 26 wh/kg when the charge/discharge rate is increased to 28.6 A/g.
the supercapacitor electrode achieves a high-power density of 10 kW/kg at a charge/discharge rate of 28.6 A/g or greater, and a high-energy density of at least 60 kW/kg at a charge/discharge rate of 1 A/g.

20. The method of claim 11, further comprising the step of:
minimizing the crystallinity of the metal oxide nanoparticles, such that the plurality of metal oxide layers have a grain size of between approximately 1-100 nm.

21. The supercapacitor electrode produced by the method of claim 11.

22. The supercapacitor of claim 8, wherein the supercapacitor electrode is a negative electrode, and
wherein the porous network of compacted metal nanoparticles comprises at least one transition metal or an alloy thereof, and
wherein the porous network of metal oxide nanoparticles comprises an oxide of the at least one transition metal or an oxide of the at least one transition metal alloy.

23. The supercapacitor electrode of claim 1, wherein the porous network of metal nanoparticles includes at least one transition metal or an alloy thereof and the porous network of metal oxide nanoparticles includes an oxide of the at least one transition metal or an oxide of the at least one transition metal alloy.
